(19) United States
(12) Patent Application Publication
(10) Pub. No.: US 2024/0412484 A1
(43) Pub. Date: Dec. 12, 2024

(54) METHOD OF AUTOMATED VIDEO QUALITY ASSURANCE

(71) Applicant: ARRIS Enterprises LLC, Horsham, PA (US)

(72) Inventors: Kanakendiran RAMACHANDIRAN, Chennai (IN); Vinod JATTI, Bengaluru (IN)

(73) Assignee: ARRIS Enterprises LLC, Horsham, PA (US)

(21) Appl. No.: 18/739,148

(22) Filed: Jun. 10, 2024

Related U.S. Application Data
(60) Provisional application No. 63/471,938, filed on Jun. 8, 2023.

(51) Int. Cl. G06V 10/74; G06T 7/00

(52) U.S. Cl. CPC G06V 10/761; G06T 7/0002; G06T 2207/30168

(57) ABSTRACT

The present disclosure describes method for automated video quality assurance. Test video and corresponding reference video comprising plurality of test frames and reference frames is received. Plurality of test frames is compared with plurality of reference frames. Synchronized output list having one or more test frames is generated until each test frame matches each reference frame in sequential order. When test frame fails to match reference frame (i) an unmatched test frame or reference frame is shifted; and (ii) set of subsequent test frames is compared with set of subsequent reference frames. When set of subsequent test frames matches set of subsequent reference frames, synchronized output list is updated by adding set of subsequent test frames. When set of subsequent test frames fails to match set of subsequent reference frames, each of remaining test frames is compared with reference frames and synchronized output list is updated.

### CROSS-REFERENCE TO RELATED APPLICATIONS

The present application claims the benefit of U.S. Provisional Application No. 63/471,938 filed Jun. 8, 2023, the contents of which are incorporated herein by reference in their entirety.

### TECHNICAL FIELD

The present disclosure generally relates to video quality assessment systems. More particularly, the present disclosure relates to a method and an apparatus for automated video quality assurance.

### BACKGROUND

Real-time video quality assessment is the most effective method to evaluate playback of video content on a target or a test device. The video quality assessment techniques test a quality the video content prior to deploying of the target device or the video content on the target device.

Generally, testing of the video content is performed by generating a playback of the video content on the test device and manually verifying the playback, which requires significant effort. For instance, the video may include a large number of frames and in such a case, analyzing each frame manually to assess the quality is a tedious and time-consuming task. Further, testing the playback of different video contents is required not just on one test device, but on several and with different configurations.

Video testing becomes even more challenging with variations in the video content and the test devices. For instance, the video content varies based on parameters such as codec, resolution, frame rate, bit rate, genre (for example: movie, sports, animation), etc. The devices vary based on platform, different versions of operating systems, video player type, etc. Further, in certain cases there may be different device models based on the different versions of the operating systems. For example, mobile devices platforms like Android and iOS include different device models along with different versions of operating systems.

The information disclosed in this background section is only for enhancement of understanding of the general background of the invention and should not be taken as an acknowledgement or any form of suggestion that this information forms the prior art already known to a person skilled in the art.

### SUMMARY

In one non-limiting embodiment of the present disclosure, a method may comprise receiving a test video and a corresponding reference video. The test video and the corresponding reference video comprises a plurality of test frames and a plurality of reference frames, respectively. The method may comprise comparing each of the plurality of test frames with each of the plurality of reference frames. The method may comprise generating a synchronized output list having one or more test frames until each test frame of the plurality of test frames matches with each reference frame of the plurality of reference frames in a sequential order. The method may further comprise performing, when a test frame of the plurality of test frames fails to match with a reference frame of the plurality of reference frames: (i) shifting at least one of an unmatched test frame among remaining test frames and an unmatched reference frame among remaining reference frames; and (ii) comparing a set of subsequent test frames of the remaining test frames with a set of subsequent reference frames of the remaining reference frames after shifting the at least one of the unmatched test frame and the unmatched reference frame. Further, the method may comprise, performing, based on the comparing, at least one of: (i) when the set of subsequent test frames matches with the set of subsequent reference frames, updating the synchronized output list by adding the set of subsequent test frames with the one or more test frames in a sequence; and (ii) when the set of subsequent test frames fails to match with the set of subsequent reference frames, comparing each of the remaining test frames with each of the remaining reference frames, and updating the synchronized output list by adding the remaining test frames with the one or more test frames in a sequence.

In another non-limiting embodiment of the present disclosure, the reference video is stored on a reference device and the test video is generated by recording a playback of the reference video on a test device on which the test video is to be tested.

In another non-limiting embodiment of the present disclosure, the method may further comprise analyzing the synchronized output list comprising a plurality of synchronized test frames with corresponding reference frame from the plurality of reference frames based on a quality metric. The quality metric may comprise at least one of, a structural similarity metric, a signal quality metric, a visual information metric, a loss metric and a pixel metric. The method may comprise generating a quality report comprising a set of synchronized test frames from the plurality of synchronized test frames.

In another non-limiting embodiment of the present disclosure, wherein the comparing is based on a pre-defined similarity score indicative of a similarity of a test frame with a reference frame. The similarity may be defined as one of, structural similarity, Peak Signal to Noise Ratio (PSNR) similarity, and visual quality similarity between the test frame and the reference frame.

In another non-limiting embodiment of the present disclosure, when the set of subsequent test frames matches with the set of subsequent reference frames, the method may comprise, at least one of, (i) updating the set of subsequent test frames to the synchronized output list by discarding the unmatched test frame when the set of subsequent test frames matches with the set of subsequent reference frames upon shifting the unmatched test frame; and (ii) updating the set of subsequent test frames to the synchronized output list by adding the unmatched reference frame when the set of subsequent test frames matches with the set of subsequent reference frames upon shifting the unmatched reference frame.

In another non-limiting embodiment of the present disclosure, the set of subsequent test frames and the set of subsequent reference frames comprises a pre-defined number of frames.

In another non-limiting embodiment of the present disclosure, an apparatus comprises a memory and at least one processor. The at least one processor is configured to receive a test video and a corresponding reference video. The test video and the corresponding reference video comprises a plurality of test frames and a plurality of reference frames, respectively. The at least one processor is configured to compare each of the plurality of test frames with each of the plurality of reference frames. The at least one processor is configured to generate a synchronized output list having one or more test frames until each test frame of the plurality of test frames matches with each reference frame of the plurality of reference frames in a sequential order. The at least one processor is further configured to perform, when a test frame of the plurality of test frames fails to match with a reference frame of the plurality of reference frames: (i) shifting at least one of an unmatched test frame among remaining test frames and an unmatched reference frame among remaining reference frames; and (ii) comparing a set of subsequent test frames of the remaining test frames with a set of subsequent reference frames of the remaining reference frames after shifting the at least one of the unmatched test frame and the unmatched reference frame. Further, the at least one processor is configured to, perform, based on the comparing, at least one of: (i) when the set of subsequent test frames matches with the set of subsequent reference frames, updating the synchronized output list by adding the set of subsequent test frames with the one or more test frames in a sequence; and (ii) when the set of subsequent test frames fails to match with the set of subsequent reference frames, comparing each of the remaining test frames with each of the remaining reference frames, and updating the synchronized output list by adding the remaining test frames with the one or more test frames in a sequence.

In another non-limiting embodiment of the present disclosure, a non-transitory computer readable medium stores one or more instructions executable by at least one processor. The one or more instructions when executed by at least one processor causes the at least one processor to receive a test video and a corresponding reference video. The test video and the corresponding reference video comprises a plurality of test frames and a plurality of reference frames, respectively. The at least one processor is configured to compare each of the plurality of test frames with each of the plurality of reference frames. The at least one processor is configured to generate a synchronized output list having one or more test frames until each test frame of the plurality of test frames matches with each reference frame of the plurality of reference frames in a sequential order. The at least one processor is further configured to perform, when a test frame of the plurality of test frames fails to match with a reference frame of the plurality of reference frames: (i) shifting at least one of an unmatched test frame among remaining test frames and an unmatched reference frame among remaining reference frames; and (ii) comparing a set of subsequent test frames of the remaining test frames with a set of subsequent reference frames of the remaining reference frames after shifting the at least one of the unmatched test frame and the unmatched reference frame. Further, the at least one processor is configured to, perform, based on the comparing, at least one of: (i) when the set of subsequent test frames matches with the set of subsequent reference frames, updating the synchronized output list by adding the set of subsequent test frames with the one or more test frames in a sequence; and (ii) when the set of subsequent test frames fails to match with the set of subsequent reference frames, comparing each of the remaining test frames with each of the remaining reference frames, and updating the synchronized output list by adding the remaining test frames with the one or more test frames in a sequence.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. Some embodiments of system and/or methods in accordance with embodiments of the present subject matter are now described, by way of example only, and with reference to the accompanying figures, in which:

FIG. 1 shows an exemplary environment illustrating automated video quality assurance, in accordance with some embodiments of the present disclosure;

FIG. 2 shows a detailed block diagram illustrating an apparatus, in accordance with some embodiments of the present disclosure;

FIG. 3 shows another block diagram illustrating an apparatus, in accordance with some embodiments of the present disclosure;

FIG. 4 shows an example of generation of a synchronized output list, in accordance with some embodiments of the present disclosure;

FIG. 5 shows an example of automated video quality assurance, in accordance with some embodiments of the present disclosure;

FIG. 6A and FIG. 6B show flowcharts illustrating a method of automated video quality assurance, in accordance with some embodiments of the present disclosure; and

It should be appreciated by those skilled in the art that any block diagram herein represent conceptual views of the illustrative system embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular form disclosed, but on the contrary, the disclosure is to cover all modifications, equivalents, and alternatives falling within the spirit and the scope of the disclosure.

The terms “comprise(s)”, “comprising”, “include(s)”, or any other variations thereof, are intended to cover a non-exclusive inclusion, such that a setup, device, apparatus, system, or method that comprises a list of components or steps does not include only those components or steps but may include other components or steps not expressly listed or inherent to such setup or device or apparatus or system or method. In other words, one or more elements in a device or system or apparatus proceeded by “comprises . . . a” does not, without more constraints, preclude the existence of other elements or additional elements in the system.

The terms like “at least one” and “one or more” may be used interchangeably or in combination throughout the description.

In the following detailed description of the embodiments of the disclosure, reference is made to the accompanying drawings that form a part hereof, and in which are shown specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense. In the following description, well known functions or constructions are not described in detail since they would obscure the description with unnecessary detail.

The present disclosure relates to a method, an apparatus, and a computer readable medium for automated video quality assurance. The present disclosure provides an automated video testing technique in which a test video is tested by referring to a reference video. The reference video is stored on a reference device. The test video is generated by recording a playback of the reference video on the test device on which the test video is to be tested. The reference video comprises a plurality of reference frames and the test video comprises a plurality of reference frames. The plurality of test frames may not be synchronized with the plurality of reference frames. For example, a frame present in the plurality of reference frames may not be present in the plurality of test frames. The present disclosure provides a method for synchronizing the plurality of test frames with the plurality of reference frames prior to testing of the test video. First, each of the plurality of test frames are compared with each of the plurality of reference frames. When a test frame matches a reference frame, the test frame is included in a synchronized output list. Similarly, one or more test frames are included until each test frame matches each reference frame to generate a synchronized output list.

When a test frame fails to match a reference frame, at least one of an unmatched test frame among remaining test frames and an unmatched reference frame among remaining reference frames is shifted. The purpose of shifting is to check the possibility of matching next frames in the sequence. That is, after shifting, the technique disclosed in the present disclosure determines whether a set of subsequent test frames matches a set of subsequent reference frames. When the set of subsequent test frames matches the set of subsequent reference frames, the synchronized output list is updated by adding the set of subsequent test frames to the one or more test frames. When the set of subsequent test frames fails to match the set of subsequent reference frames, each of the remaining test frames is compared to each of the remaining reference frames and the synchronized output list is updated by adding the remaining test frames.

The present disclosure provides an automated video testing technique that is more efficient and faster as compared to manual video testing. The present disclosure ensures that the plurality of test frames of the test video is synchronized with the plurality of references frames of the reference video. This leads to more accurate evaluation of the plurality of test frames, thus increasing accuracy and efficiency in testing of the video quality.

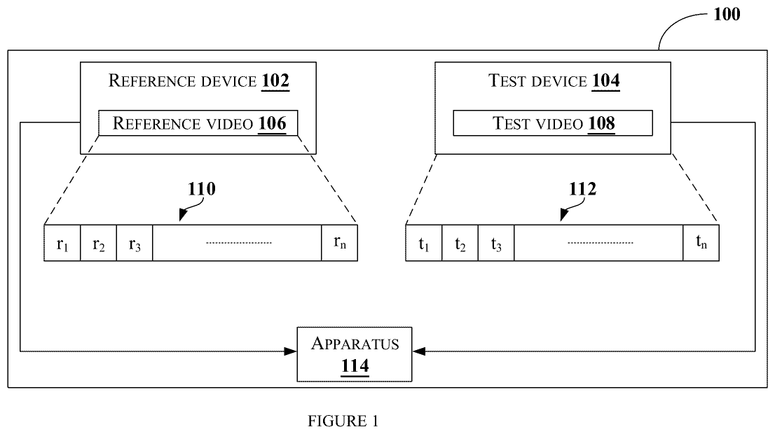

FIG. 1 shows an exemplary environment illustrating automated video quality assurance, in accordance with an embodiment of the present disclosure.

In a non-limiting embodiment, the environment 100 may include a reference device 102, a test device 104, and an apparatus 114. The reference device 102 may comprise a smartphone, a mobile phone, a personal digital assistant, a desktop computer, a laptop computer, a tablet device or any other type of computing device suitable for playing media content, for example video. A reference video 106 may be stored on the reference device 102. For example, the reference video 106 may be a movie and may include a plurality of reference frames 110 (r₁, r₂, r₃, . . . , rₙ). A reference frame may be defined as one of the many still images that compose the reference video 106. The test device 104 may include a smartphone, a mobile phone, a personal digital assistant, a desktop computer, a laptop computer, a tablet device or any other type of computing device capable of delivering content services (e.g., video) to a user. The test video 108 may include a plurality of reference frames 110 (t₁, t₂, t₃, . . . , tₙ). A test frame may be defined as one of the many still images which compose the test video 108.

In an embodiment, the test device 104 may be an upgraded version or another version of the reference device 102. For example, the reference device 102 may include a first version of a mobile device. The test device 104 may include a second version (upgraded version) of the mobile device. The video content stored or available in the first version of the mobile device (i.e., reference device 102) needs to be tested prior to launching of the video content in the second version of the mobile device (i.e., test device 104). Hence, the quality of the video content (the test video 108) on the test device 104 is analyzed by referring the reference video 106 to provide automated video quality assurance. The objective of such analysis is to create a synchronized list of frames prior to sending them for testing.

In the present disclosure, the apparatus 114 is configured to perform the automated video quality assurance. The apparatus 114 may receive the reference video 106 and the test video 108 to perform the steps of the present disclosure. In an embodiment, the apparatus 114 may be an integral part of the test device 104. In another embodiment, the apparatus 114 may be communicatively coupled with the test device 104. The apparatus 114 may include a smartphone, a mobile phone, a personal digital assistant, a desktop computer, a laptop computer, a tablet device or any other type of computing device. In yet another embodiment, the apparatus 114 may be implemented as a server, for instance, an edge server, a cloud server, and the like.

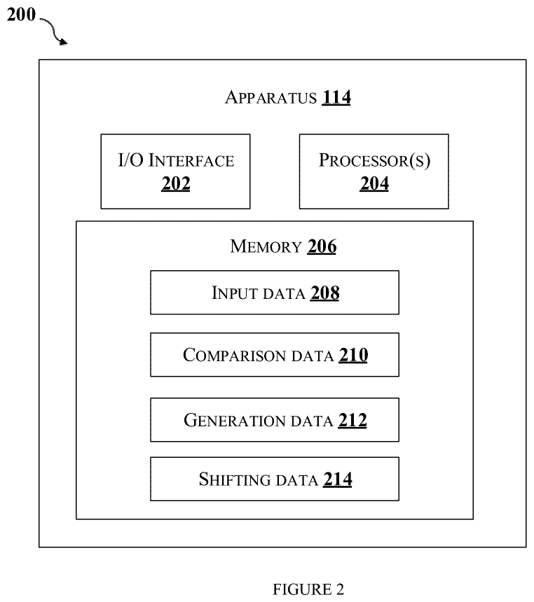

FIG. 2 shows a detailed block diagram 200 illustrating the apparatus 114, in accordance with some embodiments of the present disclosure. The apparatus 114 may comprise an I/O interface 202, at least one processor 204, and a memory 206. The I/O interface 202 may be configured to receive the test video 108 and the reference video 106 and provide a quality of the video content to a user. The memory 206 may be communicatively coupled to the at least one processor 204. The at least one processor 204 may be configured to perform one or more functions of the apparatus 114 as described in the present disclosure.

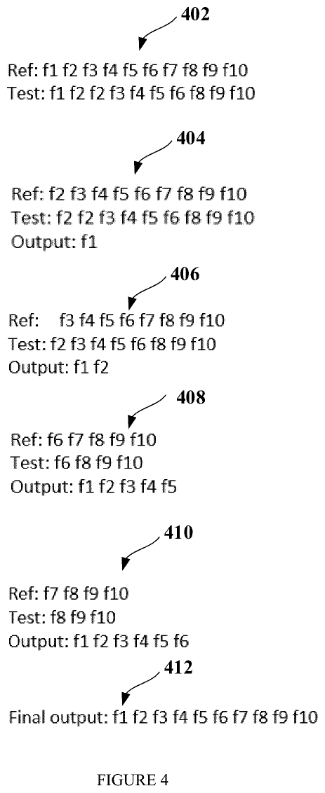

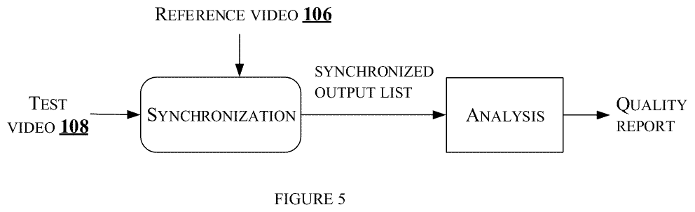

The detailed working of the apparatus 114 will now be explained using an example shown in FIG. 4 and FIG. 5.

FIG. 4 illustrates a process of synchronizing the plurality of test frames 112 with the plurality of reference frames 110 through steps 402-412. At step 402, the at least one processor 204 receives the test video 108 and the corresponding reference video 106. The reference video 106 is received from the reference device 102. The test video 108 may be generated by recording a playback of the reference video 106 on the test device 104 on which the test video 108 is to be tested. For example, the reference video 106 may be a first episode of a movie series stored on the reference device 102. The test video 108 may be generated by recording a playback of the first episode on the test device 104. FIG. 4 illustrates an exemplary plurality of reference frames f1, f2, f3, f4, f5, f6, f7, f8, f9, f10 of the reference video 106, and an exemplary plurality of test frames f1, f2, f2, f4, f4, f5, f6, f8, f9, f10.

### Mapping

The at least one processor 204 preferably compares each of the plurality of test frames 112 with each of the plurality of reference frames 110. The at least one processor 204 may compare each of the plurality of test frames 112 with each of the plurality of reference frames 110 in a sequential order. The at least one processor 204 may compare each of the plurality of test frames 112 with each of the plurality of reference frames 110 based on a pre-defined similarity score indicative of a similarity of a test frame with a reference frame. The similarity may be defined as one of structural similarity, Peak Signal to Noise Ratio (PSNR) similarity, and visual quality similarity between the test frame and the reference frame. In an embodiment, the structural similarity may be determined based least in part on a Structural Similarity Index Measure (SSIM) metric. In an embodiment, the PSNR similarity may be determined based at least in part on a Visual Information Fidelity (VIF) metric. A person skilled in the art will appreciate that other parameters can also be used to determine the similarity between each of the plurality of test frames 112 with each of the plurality of reference frames 110. Referring to step 402 in FIG. 4, the at least one processor 204 starts comparing the reference frames with test frames in a sequential order i.c., reference frame f1 is compared with test frame f1, reference frame f2 is compared with test frame f2, etc.

The at least one processor 204 may generate a synchronized output list having one or more test frames until each test frame of the plurality of test frames 112 matches with each reference frame of the plurality of reference frames 110 in the sequential order. Referring to 404 in FIG. 4, the at least one processor generates the synchronized output list including the test frame f1 as the test frame f1 matches the reference frame f1. Similarly, referring to 406 in FIG. 4, the at least one processor includes the test frame f2 in the synchronized output list as the test frame f2 matches the reference frame f2.

### Shifting and Window Mapping

However, when a test frame of the plurality of test frames 112 fails to match a reference frame of the plurality of reference frames 110, the at least one processor 204 may shift at least one of an unmatched test frame among remaining test frames and an unmatched reference frame among remaining reference frames. Referring to step 406 in FIG. 4, since a test frame f2 does not match a reference frame f3, the at least one processor 204 shifts the unmatched test frame f2 to see whether the next few sets of test frames match the corresponding next few sets of reference frames. Thus, the at least one processor 204 compares a set of subsequent test frames of the remaining test frames with a set of subsequent reference frames of the remaining reference frames after shifting the at least one of the unmatched test frame and the unmatched reference frame. In an embodiment, the set of subsequent test frames and the set of subsequent reference frames comprise a pre-defined number of frames, for example the next three frames or the next five frames. The pre-defined number of frames are also referred as a window. The example in FIG. 4 considers the pre-defined number of frames or a window size as three. Thus, the at least one processor 204 compares next three test frames with next three reference frames upon performing the shifting. Referring to step 406, the at least one processor 204 compares set of subsequent test frames f3, f4, f5 with set of subsequent reference frames f3, f4, f5.

When the set of subsequent test frames matches the set of subsequent reference frames, the at least one processor 204 updates the synchronized output list by adding the set of subsequent test frames to the one or more test frames in a sequence. Referring to step 408 in FIG. 4, the at least one processor 204 updates the synchronized output list by adding the set of subsequent test frames f3, f4, f5. The purpose of shifting and window mapping (as described above) is to quickly identify a next possible set of test frames that match a corresponding set of reference frames, thereby making the matching process efficient.

According to another embodiment, the at least one processor 204 may update the set of subsequent test frames to the synchronized output list by discarding the unmatched test frame when the set of subsequent test frames matches the set of subsequent reference frames upon shifting the unmatched test frame. For instance, referring to the step 406, the set of subsequent test frames f3, f4, f5 matches the set of subsequent reference frames f3, f4, f5 upon shifting the unmatched test frame f2. Hence, the at least one processor 204 updates the set of subsequent test frames f3, f4, f5 by discarding the unmatched test frame f2. This avoids any duplication while updating the synchronized output list. In this example, frame f2 is a duplicate frame present in the plurality of test frames 112, and hence is discarded.

When the set of subsequent test frames matches the set of subsequent reference frames after shifting the reference frame instead of test frame, the at least one processor 204 updates the set of subsequent test frames to the synchronized output list by adding that unmatched reference frame. This ensures that none of the reference frames are discarded (even if unmatched) while generating synchronized output list. For instance, referring to step 408, a test frame f6 matches a reference frame f6. But the next test frame i.c., test frame f8 does not match a next reference frame i.c., reference frame f7. Preferably, the at least one processor 204 shifts an unmatched test frame f8 to see whether the next set of test frames matches the corresponding next set of reference frames. If the set of subsequent test frames fail to match the set of subsequent reference frames upon such shifting, the at least one processor 204 now shifts an unmatched reference frame (f7) to again sec whether the next set of test frames matches the corresponding next set of reference frames as shown in step 410 in FIG. 4. Upon shifting, the at least one processor observes that the set of subsequent test frames f8, f9, f10 matches the set of subsequent reference frames f8, f9, f10. Hence, the at least one processor 204 updates the set of subsequent test frames to the synchronized output list by adding the unmatched reference frame f7. The unmatched reference frame f7 is a missing frame in the plurality of test frames 112. A final synchronized output list including a plurality of synchronized test frames is generated as shown in step 412 in FIG. 4.

There could be a scenario where even after shifting and window mapping, the set of subsequent test frames fails to match the set of subsequent reference frames. For example, after shifting, it can be observed that next set of frames do not fall within the number of frames pre-defined for a window. In other words, the remaining test frames or the remaining reference frames may be less than the pre-defined window size. In such scenario, the at least one processor 204 compares each of the remaining test frames with each of the remaining reference frames using one-to-one mapping. Then, the at least one processor 204 updates the synchronized output list by adding the remaining test frames with the one or more test frames in a sequence. For instance, consider a test video 108 and a reference video 106 with 100 frames and 99 frames, respectively. The remaining test frames and the remaining reference frames may be two and one, respectively, whereas the window size may be three. In such case, the at least one processor 204 may compare the remaining test frames with the remaining reference frames by performing the one-to-one mapping.

Reference is now made to FIG. 5, which illustrates an exemplary method of automated video quality assurance in accordance with some embodiments of the present disclosure. In this exemplary method, the at least one processor 204 is configured to synchronize the plurality of test frames 112 with the plurality of reference frames 110 as described above. Further, the at least one processor 204 may be configured to analyze the synchronized output list comprising the plurality of synchronized test frames with corresponding reference frames from the plurality of reference frames 110 based on a quality metric. The quality metric may comprise at least one of a structural similarity metric, a signal quality metric, a visual information metric, a loss metric, a pixel metric, etc. A quality score may be associated with each of the plurality of synchronized test frames, based upon the analysis. In an embodiment, the plurality of synchronized test frames may be analyzed with corresponding references frame using a Video Multi-Method Assessment Fusion (VMAF) technique. In such a case, the structural similarity metric may comprise a Structural Similarity Index Measure (SSM) metric, the signal quality metric may comprise a Peak Signal to Noise Ratio (PSNR) metric, the visual information metric may comprise a Visual Information Fidelity (VIF) metric, the loss metric may comprise a Detail Loss (DL) Metric, and the pixel metric may comprise a Mean Co-Located Pixel Difference (MCPD) metric. A person skilled in the art will appreciate that any techniques other than the above-mentioned techniques may be used to analyze the plurality of synchronized test frames with corresponding reference frames. Then, the at least one processor 204 may generate a quality report based on the plurality of synchronized test frames after removing a subset of the synchronized test frames from the plurality of synchronized test frames. The subset of synchronized test frames to be removed may be selected for removal from the plurality of synchronized test frames when the quality score of the frames in the subset is less than a pre-defined threshold value, and in some further embodiments also when the subset to be removed is of a number less than a pre-defined limit value. For example, consider a subset of synchronized test frames that have a quality score less than a pre-defined threshold value, where the number of frames in the subset is 3 out of 1000 frames, and where the predefined limit value is 0.5%. The at least one processor 204 may not consider the set of synchronized test frames when generating the quality report. Alternatively, if a subset of synchronized test frames that have a quality score less than a pre-defined threshold value, where the number of frames in the subset is 20 out of 1000 frames and where the predefined limit value is 0.5%., the at least one processor 204 may consider the set of synchronized test frames while generating the quality report.

In an embodiment, the present disclosure is also applicable to adaptive streaming. In adaptive streaming, there may be different variants (bitrate) of the video in a playlist file and a video player is free to switch between them based on existing network conditions. For instance, when the available bandwidth drops, the video player chooses the lower bit rate (low quality) and when the available bandwidth is improves, the video player chooses a higher bitrate (high quality) video. In such case, the present disclosure performs the automated video quality assurance by capturing one reference video per variant. During testing, the video player may provide information about its variant as a metadata (through logs/API). The information may comprise a time offset from the start, the variant played, and the like. The reference video 106 for comparison may be composed based on the metadata and the captured reference video 106 of the variants. Then, the same method as described in above paragraphs may be used for testing the test video 108 with the reference video 106.

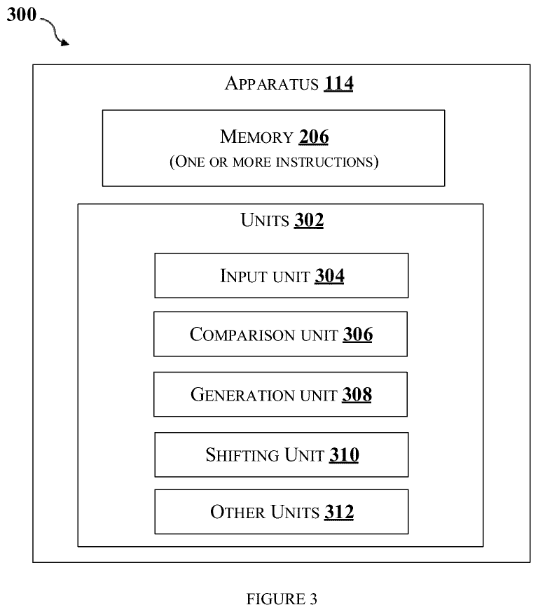

In another non-limiting embodiment of the present disclosure, the apparatus 114 may comprise various units or means as shown in FIG. 3. The units 302 may comprise an input unit 304, a comparison unit 306, a generation unit 308, a shifting unit 310, and other units 312. In an embodiment, the units 304-312 may be dedicated hardware units capable of executing one or more instructions stored in the memory 206 for performing various operations of the apparatus 114. In another embodiment, the units 304-312 may be software modules stored in the memory 206 which may be executed by the at least one processor 204 for performing the operations of the apparatus 114.

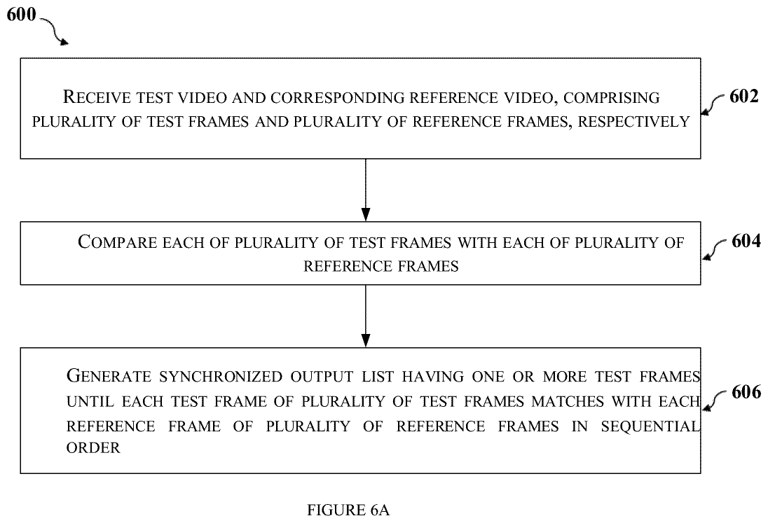

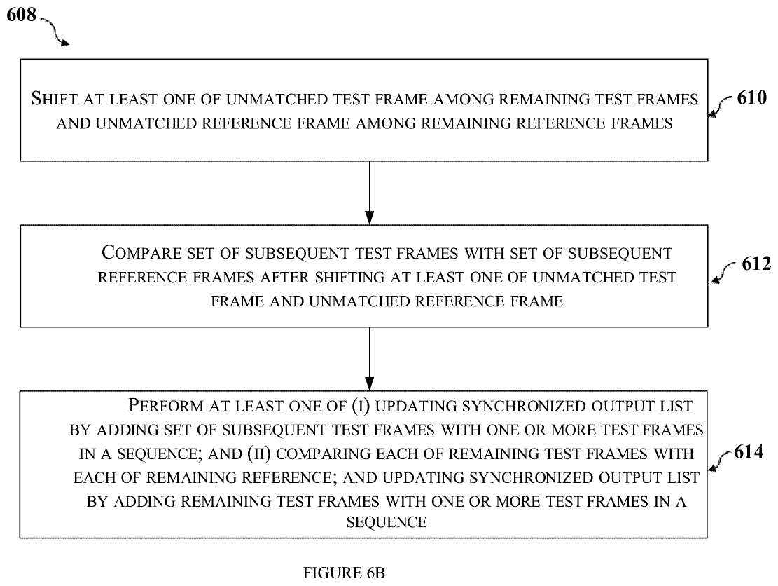

FIG. 6A and FIG. 6B show flowcharts illustrating embodiments of a method of automated video quality assurance, according to the foregoing description.

As illustrated in FIG. 6A, a method 600 comprises one or more blocks for automated video quality assurance using an apparatus 114. The method 600 may be described in the general context of computer executable instructions. Generally, computer executable instructions can include routines, programs, objects, components, data structures, procedures, modules, and functions, which perform particular functions or implement particular abstract data types.

The order in which the method 600 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 602, the method may include receiving the test video 108 and a corresponding reference video 106, comprising the plurality of test frames 112 and the plurality of reference frames 110, respectively. The operations of block 602 may be performed by the at least one processor 204 (of FIG. 2) or an input unit 304 (of FIG. 3) and corresponding data may be stored as input data 208 in the memory 206.

At block 604, the method includes comparing each of the plurality of test frames 112 with each of the plurality of reference frames 110. The operations of block 504 may be performed by the at least one processor 204 (of FIG. 2) or a comparison unit 306 (of FIG. 3) and corresponding data may be stored as comparison data 210 in the memory 206.

At block 606, the method includes generating a synchronized output list having one or more test frames until each test frame of the plurality of test frames 112 matches each reference frame of the plurality of reference frames 110 in a sequential order. The operations of block 606 may be performed by the at least one processor 204 (of FIG. 2) or a generation unit 308 (of FIG. 3) and corresponding data may be stored as generation data 212 in the memory 206.

As illustrated in FIG. 6B, the method 608 comprises one or more blocks for automated video quality assurance using an apparatus 114. The method 608 may be described in the general context of computer executable instructions. Generally, computer executable instructions can include routines, programs, objects, components, data structures, procedures, modules, and functions, which perform particular functions or implement particular abstract data types.

The order in which the method 608 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 610, the method may include shifting at least one of an unmatched test frame among remaining test frames and an unmatched reference frame among remaining reference frames, when a test frame of the plurality of test frames 112 fails to match a reference frame of the plurality of reference frames 110. The operations of block 610 may be performed by the at least one processor 204 (of FIG. 2) or a shifting unit 310 (of FIG. 3) and corresponding data may be stored as shifting data 214 in the memory 206.

At block 612, the method includes comparing a set of subsequent test frames of the remaining test frames with a set of subsequent reference frames of the remaining reference frames after shifting the at least one of the unmatched test frame and the unmatched reference frame. The operations of block 612 may be performed by the at least one processor 204 (of FIG. 2) or the comparison unit 306 (of FIG. 3) and corresponding data may be stored as the comparison data 210 in the memory 206.

At block 614, the method includes performing, based on the comparing, at least one of (i) when the set of subsequent test frames matches the set of subsequent reference frames, updating the synchronized output list by adding the set of subsequent test frames with the one or more test frames in a sequence; and (ii) when the set of subsequent test frames fails to match the set of subsequent reference frames, comparing each of the remaining test frames with each of the remaining reference frames; and updating the synchronized output list by adding the remaining test frames with the one or more test frames in a sequence. The operations of block 614 may be performed by the at least one processor 204 (of FIG. 2) or the generation unit 308 and the comparison unit 306 (of FIG. 3) and corresponding data may be stored as the generation data 212 and the comparison data 210 in the memory 206.

In a non-limiting embodiment of the present disclosure, one or more non-transitory computer-readable media may be utilized for implementing the embodiments consistent with the present invention. A computer-readable media refers to any type of physical memory (such as the memory 206) on which information or data readable by a processor may be stored. Thus, a computer-readable media may store one or more instructions for execution by the at least one processor 204, including instructions for causing the at least one processor 204 to perform steps or stages consistent with the embodiments described herein. The term “computer-readable media” should be understood to include tangible items and exclude carrier waves and transient signals. By way of example, and not limitation, such computer-readable media can comprise Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Thus, certain aspects may comprise a computer program product for performing the operations presented herein. For example, such a computer program product may comprise a computer readable media having instructions stored (and/or encoded) thereon, the instructions being executable by one or more processors to perform the operations described herein. For certain aspects, the computer program product may include packaging material.

The various illustrative logical blocks, modules, and operations described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may include a microprocessor, but in the alternative, the processor may include any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

As used herein, a phrase referring to “at least one” or “one or more” of a list of items refers to any combination of those items, including single members. As an example, “at least one of: a, b, or c” is intended to cover: a, b, c, a-b, a-c, b-c, and a-b-c. The terms “a”, “an” and “the” mean “one or more”, unless expressly specified otherwise.

The terms “an embodiment”, “embodiment”, “embodiments”, “the embodiment”, “the embodiments”, “one or more embodiments”, “some embodiments”, and “one embodiment”, “other embodiment”, “yet another embodiment”, “non-limiting embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

A description of an embodiment with several components in communication with each other does not imply that all such components are required. On the contrary, a variety of optional components are described to illustrate the wide variety of possible embodiments of the invention.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the appended claims.

What is claimed is:

1. A method comprising:
receiving a test video and a corresponding reference video, comprising a plurality of test frames and a plurality of reference frames, respectively;
comparing each of the plurality of test frames with each of the plurality of reference frames; and
generating a synchronized output list having one or more test frames until each test frame of the plurality of test frames matches each reference frame of the plurality of reference frames in a sequential order,
wherein the method further comprises performing, when a test frame of the plurality of test frames fails to match a reference frame of the plurality of reference frames:
shifting at least one of an unmatched test frame among remaining test frames and an unmatched reference frame among remaining reference frames; and
comparing a set of subsequent test frames of the remaining test frames with a set of subsequent reference frames of the remaining reference frames after shifting the at least one of the unmatched test frame and the unmatched reference frame; and
performing, based on the comparing, at least one of:
when the set of subsequent test frames matches with the set of subsequent reference frames, updating the synchronized output list by adding the set of subsequent test frames with the one or more test frames in a sequence; and
when the set of subsequent test frames fails to match with the set of subsequent reference frames,
comparing each of the remaining test frames with each of the remaining reference frames; and
updating the synchronized output list by adding the remaining test frames with the one or more test frames in a sequence.

2. The method of claim 1, wherein the reference video is stored on a reference device and the test video is generated by recording a playback of the reference video on a test device on which the test video is to be tested.

3. The method of claim 1, further comprising:
analyzing the synchronized output list comprising a plurality of synchronized test frames with corresponding reference frame from the plurality of reference frames based on a quality metric, wherein the quality metric comprises at least one of, a structural similarity metric, a signal quality metric, a visual information metric, a loss metric and a pixel metric; and
generating a quality report comprising a set of synchronized test frames from the plurality of synchronized test frames.

4. The method of claim 1, wherein the comparing is based on a pre-defined similarity score indicative of a similarity of a test frame with a reference frame, wherein the similarity is defined as one of, structural similarity, Peak Signal to Noise Ratio (PSNR) similarity, and visual quality similarity between the test frame and the reference frame.

5. The method of claim 1, wherein when the set of subsequent test frames matches with the set of subsequent reference frames, comprises, at least one of,
updating the set of subsequent test frames to the synchronized output list by discarding the unmatched test frame when the set of subsequent test frames matches the set of subsequent reference frames upon shifting the unmatched test frame; and
updating the set of subsequent test frames to the synchronized output list by adding the unmatched reference frame when the set of subsequent test frames matches the set of subsequent reference frames upon shifting the unmatched reference frame.

6. The method of claim 1, wherein the set of subsequent test frames and the set of subsequent reference frames comprises a pre-defined number of frames.

7. An apparatus comprising:
a memory; and
at least one processor communicatively coupled with the memory and configured to:
receive a test video and a corresponding reference video, comprising a plurality of test frames and a plurality of reference frames, respectively;
compare each of the plurality of test frames with each of the plurality of reference frames; and
generate a synchronized output list having one or more test frames until each test frame of the plurality of test frames matches each reference frame of the plurality of reference frames in a sequential order,
wherein the method further comprises performing, when a test frame of the plurality of test frames fails to match a reference frame of the plurality of reference frames:
shifting at least one of an unmatched test frame among remaining test frames and an unmatched reference frame among remaining reference frames; and
comparing a set of subsequent test frames of the remaining test frames with a set of subsequent reference frames of the remaining reference frames after shifting the at least one of the unmatched test frame and the unmatched reference frame; and
performing, based on the comparing, at least one of:
when the set of subsequent test frames matches the set of subsequent reference frames, updating the synchronized output list by adding the set of subsequent test frames with the one or more test frames in a sequence; and
when the set of subsequent test frames fails to match the set of subsequent reference frames,
comparing each of the remaining test frames with each of the remaining reference frames; and
updating the synchronized output list by adding the remaining test frames with the one or more test frames in a sequence.

8. The apparatus of claim 7, wherein the reference video is stored on a reference device and the test video is generated by recording a playback of the reference video on a test device on which the test video is to be tested.

9. The method of claim 7, wherein the at least one processor is further configured to:
analyze the synchronized output list comprising a plurality of synchronized test frames with corresponding reference frame from the plurality of reference frames based on a quality metric, wherein the quality metric comprises at least one of, a structural similarity metric, a signal quality metric, a visual information metric, a loss metric and a pixel metric; and
generate a quality report comprising a set of synchronized test frames from the plurality of synchronized test frames.

10. The apparatus of claim 7, wherein the comparing is based on a pre-defined similarity score indicative of a similarity of a test frame with a reference frame, wherein the similarity is defined as one of structural similarity, Peak Signal to Noise Ratio (PSNR) similarity, and visual quality similarity between the test frame and the reference frame.

11. The apparatus of claim 7, wherein when the set of subsequent test frames matches the set of subsequent reference frames, the at least one processor is configured to perform, at least one of,
update the set of subsequent test frames to the synchronized output list by discarding the unmatched test frame when the set of subsequent test frames matches the set of subsequent reference frames upon shifting the unmatched test frame; and
update the set of subsequent test frames to the synchronized output list by adding the unmatched reference frame when the set of subsequent test frames matches the set of subsequent reference frames upon shifting the unmatched reference frame.

12. The apparatus of claim 7, wherein the set of subsequent test frames and the set of subsequent reference frames comprises a pre-defined number of frames.

13. A non-transitory computer readable medium comprising one or more instructions which, when executed by at least one processor causes the at least one processor to:
receive a test video and a corresponding reference video, comprising a plurality of test frames and a plurality of reference frames, respectively;
compare each of the plurality of test frames with each of the plurality of reference frames; and
generate a synchronized output list having one or more test frames until each test frame of the plurality of test frames matches each reference frame of the plurality of reference frames in a sequential order,
wherein the method further comprises performing, when a test frame of the plurality of test frames fails to match a reference frame of the plurality of reference frames:
shifting at least one of an unmatched test frame among remaining test frames and an unmatched reference frame among remaining reference frames; and
comparing a set of subsequent test frames of the remaining test frames with a set of subsequent reference frames of the remaining reference frames after shifting the at least one of the unmatched test frame and the unmatched reference frame; and
performing, based on the comparing, at least one of:
when the set of subsequent test frames matches the set of subsequent reference frames, updating the synchronized output list by adding the set of subsequent test frames with the one or more test frames in a sequence; and
when the set of subsequent test frames fails to match the set of subsequent reference frames,
comparing each of the remaining test frames with each of the remaining reference frames; and
updating the synchronized output list by adding the remaining test frames with the one or more test frames in a sequence.
